(19) United States
(12) Patent Application Publication
(10) Pub. No.: US 2011/0316768 A1
(43) Pub. Date: Dec. 29, 2011

(54) SYSTEM, METHOD AND APPARATUS FOR SPEAKER CONFIGURATION

(75) Inventor: Matthew Blake McRae, Laguna Beach, CA (US)

(73) Assignee: VIZIO, INC., Irvine, CA (US)

(21) Appl. No.: 12/824,512

(22) Filed: Jun. 28, 2010

(51) Int. Cl. H04B 3/02; G09G 5/00

(52) U.S. Cl. 345/156; 381/80

(57) ABSTRACT

An application for a device includes at least two speakers and at least two-channels of audio. The at least two-channels of audio are selectively routed to the at least two speakers. Routing of the audio to the speakers is made based upon an orientation of the device. The orientation of the device and therefore the speaker configuration is either manually changed by a viewer input or is automatically detected such as when a hand-held device is rotated, for example, to view a display of the device in portrait mode instead of landscape mode.

### FIELD OF THE INVENTION

This invention relates to the field of audio devices and more particularly to automatically adjusting multi-speaker system.

### BACKGROUND OF THE INVENTION

Devices such as televisions, media players, cellular phones, etc. often have multiple integrated speakers. Many such devices are intended for operation at any angle, particularly horizontally and rotated 90, 180 or 270 degrees. For example, LCD or plasma televisions are often rotated 90 degrees to show lists such as in airports, trade shows, etc. Furthermore, many hand-held display devices such as media players, portable televisions and cellular phones operate in various orientations, often having orientation sensors that detect the current orientation and properly orientate the image presented on their display.

Devices such as televisions, media players, cellular phones, etc. often include audio amplification and delivery through several internal speakers, providing audio output in various modes including monaural, stereo and multi-channel modes. Usually, the audio channels are connected to speakers that are strategically placed around the display to best reproduce the audio as intended by the content provider. For example when two speakers are present for stereo, a left speaker is positioned towards the left of the device (e.g. television) and a right speaker is positioned towards the right of the device, thereby presenting left sounds roughly left of the display and right sounds roughly right of the display, as preferred in stereo audio reproduction. Sometimes, a center speaker is also provided and is often centrally located between the left and right sides of the device (e.g. television). When the device is rotated, for example, 90 degrees, such speakers are now all located on the left side of the device and no speakers are located on the right side of the device, or visa versa when the device is rotated 270 degrees. When the device is rotated 180 degrees, the left and right sides are on top, but reversed. Therefore, even if the image being displayed is rotated, the multi-channel sound is not correctly reproduced. For example, when the device is rotated 90 degrees, all of the sound emanates from the left of a device, etc.

What is needed is a device that reconfigures two or more speakers when used in a rotated configuration.

### SUMMARY

The present invention comprises a device that has at least two speakers. Audio routed to the at least two speakers is configured based upon an orientation of the device. The speaker configuration is either manually changed (mechanical or software switch) such as when the device (television) is rotated 90 degrees or is automatically changed such as when a hand-held device with an orientation detector is rotated, for example when the image is viewed in portrait mode instead of landscape view.

In one embodiment, a system for configuring speakers associated with a device is disclosed. The device has a display and at least two speakers and a detector for detecting an orientation of the device. A processor of the device is operatively coupled to the display and detector and controls an orientation of an image displayed on the display responsive to detecting a change in orientation. The device also has an amplifier with at least two outputs and a switch that selectively connect each of the speakers to each of the outputs. The processing element connects appropriate speakers to each of the outputs corresponding to the orientation of the image.

In another embodiment, a method of configuring speakers associated with a device is disclosed. The device has a display, at least two channels of audio and at least two speakers. The method includes determining an orientation of the device and displaying an image on the display relative to the orientation of the device. Subsets of the speakers are connected to each the audio channels relative to the orientation of the device.

In another embodiment, a system for configuring speakers associated with a device is disclosed. The device has a display, a first speaker, a second speaker, a third speaker, a fourth speaker, a left audio channel, a right audio channel and a system for routing. The system for routing selectively routes the left of right audio channels to any of the speakers. The device also has a detector that detects the orientation of the device in the range of zero, 90, 180 and 270. When the orientation is zero degrees, the left audio channel is routed to the first speaker and the right audio channel is routed to the fourth speaker by the system for routing. When the orientation is 90 degrees, the left audio channel is routed to the fourth speaker and the right audio channel is routed to the third speaker, and so fourth.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a device having multiple, configurable speakers.

FIG. 2 illustrates a plan view of a device having multiple, configurable speakers rotated 90 degrees.

FIG. 3 illustrates a plan view of a device having multiple, configurable speakers rotated 180 degrees.

FIG. 4 illustrates a plan view of a device having multiple, configurable speakers rotated 270 degrees.

FIG. 5 illustrates a schematic view of a typical multi-speaker device.

FIG. 6 illustrates a schematic view of an exemplary speaker configuration system.

FIG. 7 illustrates a typical flow chart for speaker configuration.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. The examples described in this document show portable display devices such as media players (e.g. video player, music player, etc) and television devices. Any device is anticipated that has any type of display (e.g. LCD, LED, Plasma, CRT, OLED, e-paper, etc) and at least two speakers. Devices include, but are not limited to, televisions, portable televisions, cellular phones, media players, video players, music players, monitors, computer systems, notebook computer systems, electronic books, tablet computers, etc. One example of a circuit for connecting/routing various sources of audio to various audio reproduction devices (e.g. speakers) is shown. The example is a multiplexor or switch. There are many ways known to route sources of audio to audio reproduction devices, including, but not limited to decoding the audio at a processor for delivery the desired reproduction device, routing the audio channels to different inputs of amplifiers, etc.

Many device shapes and sizes are anticipated. Although a substantially rectangular-faced device is shown in the examples presented, any shape and/or size face and thickness of device is anticipated, including a square-faced device, a round-faced device, a hexagonal-faced device, etc. There is no restriction on the size, shape, thickness of the device. Likewise, there is no restriction on the size and shape of the display or the ratio of display size to face-size (or bezel size). Any device having a display and at least two speakers is anticipated here within.

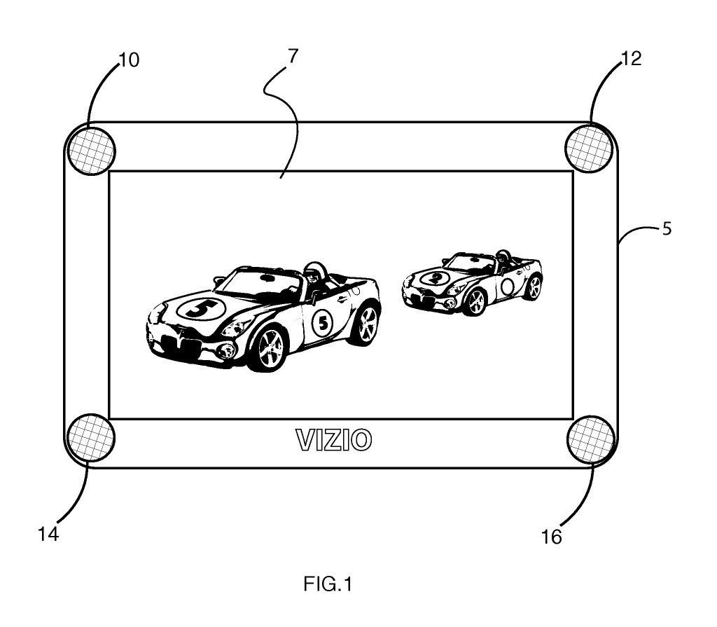

Referring to FIG. 1, a plan view of a device 5 having multiple, configurable speakers 10/12/14/16 is described. Although two or more speakers 10/12/14/16 are anticipated, the examples shown include four speakers 10/12/14/16. In this example, the speakers 10/12/14/16 are located on the periphery of the display 7, in the corners, though it is anticipated that speakers are located at any location on the device including the front surface, back surface, side surface, bezel, corners, etc. For example, one embodiment has eight speakers (not shown) having corner speakers 10/12/14/16 (as shown) and center channel speakers (not shown) situated mid-way between each of the corner speakers 10/12/14/16.

As shown, the program on the display 7 is being viewed in landscape mode (wider than tall). For proper listening pleasure, one or both left speakers 10/14 are connected to a left audio channel and one or both right speakers 12/16 are connected to a right audio channel. In this way, sounds that relate to objects on the left area of the program on the display 7 appear to come from the left speakers 10/14 and sounds that relate to objects in the right area of the program appear to come from the right speakers 12/16, as expected in stereo sound.

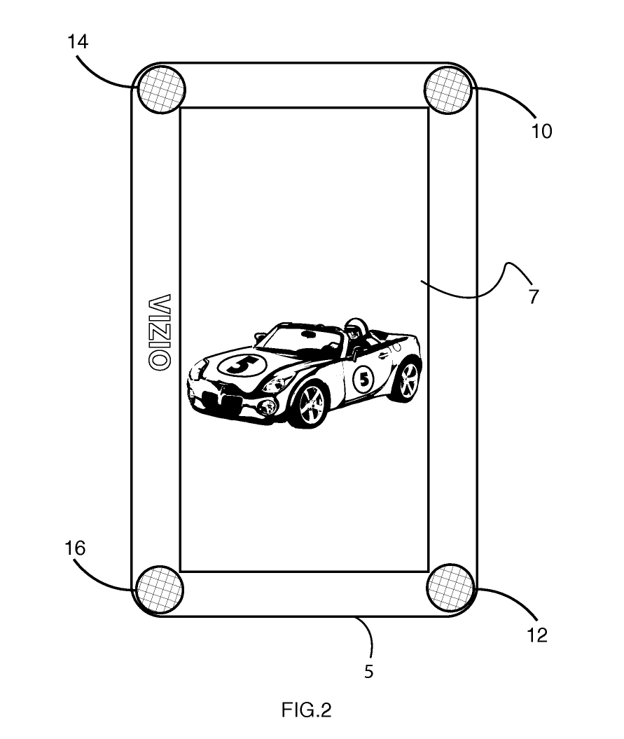

Referring to FIG. 2, a plan view of a device 5 having multiple, configurable speakers 10/12/14/16 is shown rotated 90 degrees. In this example, the viewer (or installer in the example of a large television) has rotated the device 5 by 90 degrees to the right. Either by a directive (e.g. on-screen control or command) or responsive to sensing the rotation, the image on the display 7 has been rotated by the same 90 degrees, resulting in a portrait view (taller than wide). The image on the display 7 is correctly portrayed to the viewer, but now the left audio comes from the speakers 10/14 that are now on the top of the device 5 and right audio comes from the speakers 12/16 that are now on the bottom.

This is remedied by changing the speaker configuration. In some embodiments, one or both of the new left speakers 14/16 are connected to the left audio channel and one or both of the new right speakers 10/12 are connected to the right audio channel. In some embodiments, the audio decoding routes the audio channels to the appropriate speakers. In this, after detecting the rotation, receiving a command from the user or sensing a change of a switch position, the software redirects the audio channels to the appropriate speakers.

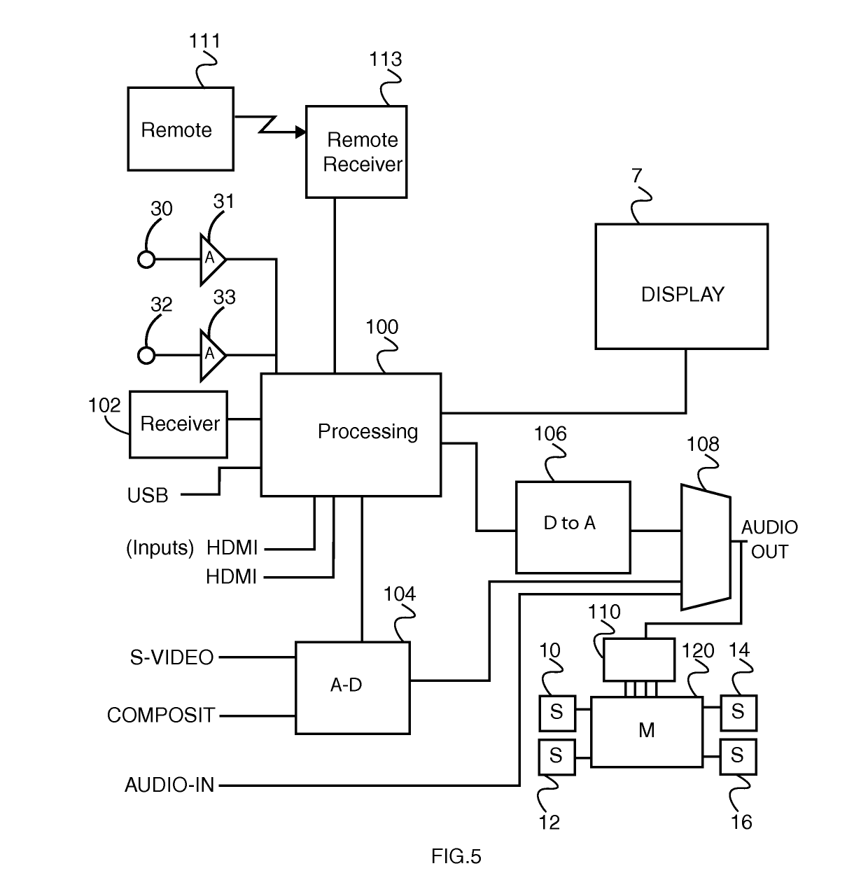

It is anticipated that either an automatic orientation detector 30/32 (see FIG. 5) or manual orientation input (e.g. remote 111 in FIG. 5) or both are used to set/determine orientation. It is also anticipated that, in some embodiments when both are present, the manual orientation input is allowed to override the automatic orientation detector 30/32, for use when the viewer is at the same orientation as the device 5 such as when the viewer lay on their side and wish to view the display 7 at the same angle.

In a preferred embodiment, the granularity of rotation is zero, 90, 180 and 270 For example zero is between 315 degrees and 45 degrees, 90 is between 45 degrees and 135 degrees, 180 is between 135 degrees and 225 degrees and 270 degrees is between 225 degrees and 315 degrees.

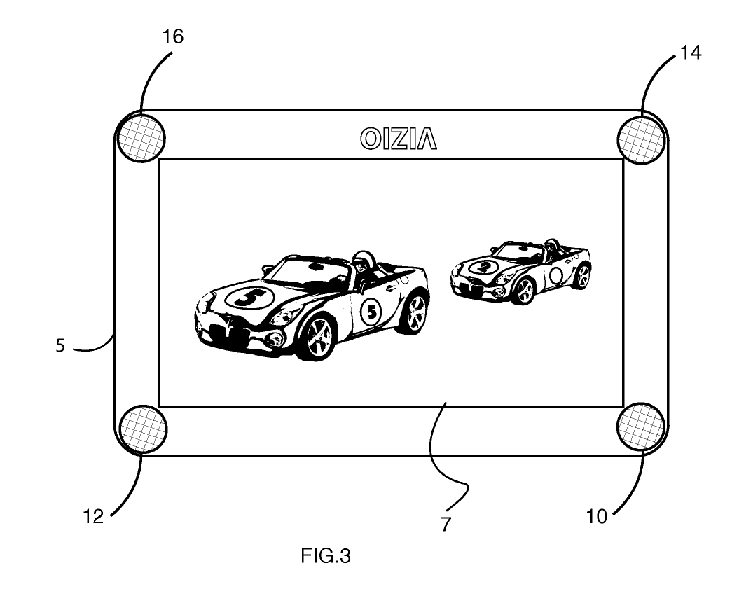

Referring to FIG. 3, a plan view of a device 5 having multiple, configurable speakers 10/12/14/16 is shown rotated 180 degrees. In this example, the viewer (or installer in the example of a large television) has rotated the device 5 by 180 degrees to the right. Either by a directive (e.g. on-screen control or command) or responsive to sensing the rotation, the image on the display 7 has been rotated by the same 180 degrees, resulting in a landscape view (wider than taller). The image on the display 7 is correctly portrayed to the viewer, but now the speakers 10/14 that were originally on the left are now on the right and the speakers 12/16 that were originally on the right are now on the left. This is remedied by changing the speaker configuration so that one or both of the new left speakers 12/16 receive the left audio channel and one or both of the new right speakers 10/14 receive the right audio channel.

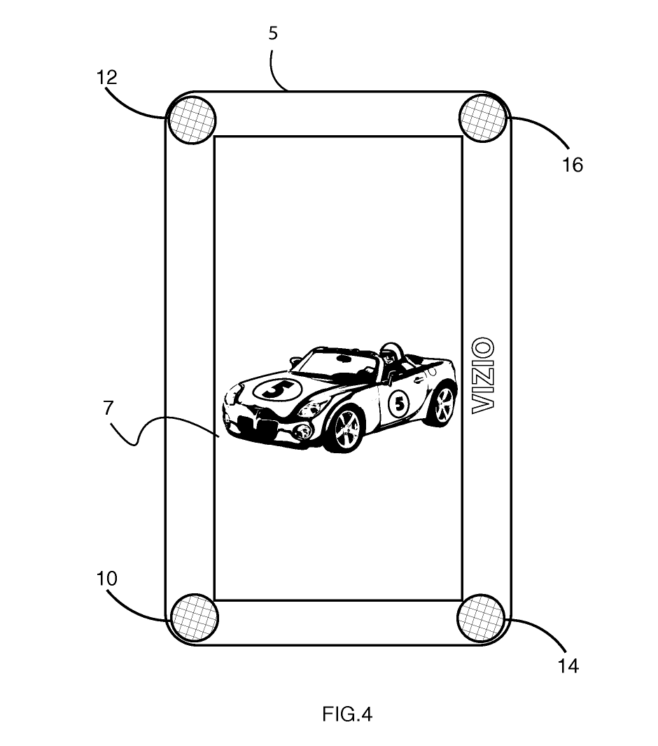

Referring to FIG. 4, a plan view of a device 5 having multiple, configurable speakers 10/12/14/16 is shown rotated 270 degrees. In this example, the viewer (or installer in the example of a large television) has rotated the device 5 by 270 degrees to the right. Either by a directive (e.g. on-screen control or command) or responsive to sensing the rotation, the image on the display 7 has been rotated by the same 270 degrees, resulting in a portrait view (taller than wide). The image on the display 7 is correctly portrayed to the viewer, but now what used to be the left speakers 10/14 are now on the bottom and what used to be the right speakers 12/16 are now on the top. This is remedied by changing the speaker configuration so that one or both of the new left speakers 10/12 receive the left audio channel and one or both of the new right speakers 14/16 receive the right audio channel.

In an exemplary minimal configuration, the device 5 has a display 7, a lower left speaker 14, an upper left speaker 10 and a lower right speaker, a left audio channel and a right audio channel. This exemplary minimal configuration has two modes of operation, landscape as shown in FIG. 1 and portrait as shown in FIG. 4. When in landscape, the lower left speaker 14 is connected to the left audio channel and the lower right speaker 16 is connected to the right audio channel. When in portrait, the upper left speaker 10 receives (or is connected to) the left audio channel and the lower left speaker 14 receives (or is connected to) connected to the right audio channel. Such a configuration is an example of a hand-held media player with speakers 10/14/16 such as an iPod with speakers 10/14/16. The rotational mode is detected (or a command is deciphered or a change of a switch setting is sensed) and the speakers receive the proper audio outputs depending upon how the device/media player 5 is held. Again, any number of speakers and audio channels is anticipated including left/right speakers 10/12/14/16, center speakers (not shown), rear speakers (not shown), edge mounted speakers (not shown), etc. The audio channels emanate from, for example, stereo sound or multichannel audio such as Dolby, Dolby Surround, DTS, Dolby Pro logic.

Referring to FIG. 5, a schematic view of a typical multi-speaker device 5 is described. This figure is intended as a representative schematic of a typical television 5 and in practice, some elements are not present in some monitors/televisions 5 and/or additional elements are present in some monitors/televisions 5. In this example, a display panel 7 is connected to a processing element 100. The display panel 7 is representative of any known display panel including, but not limited to, LCD display panels, Plasma display panels, OLED display panels, LED display panels and cathode ray tubes (CRTs).

The processing element 100 accepts video inputs and audio inputs selectively from a variety of sources including an internal television broadcast receiver 102, High-definition Media Inputs (HDMI), USB ports and an analog-to-digital converter 104. The analog-to-digital converter 104 accepts analog inputs from legacy video sources such as S-Video and Composite video and converts the analog video signal into a digital video signal before passing it to the processing element 100. The processing element 100 controls the display of the video at the proper aspect ratio and orientation on the display panel 7.

The processing element 100 accepts commands from a remote control 111 through remote receiver 113. Although IR is often used to communicate commands from the remote control 111 to the remote receiver 113, any known wireless technology is anticipated for connecting the remote control 111 to the processing element 100 including, but not limited to, radio frequencies (e.g., Bluetooth), sound (e.g., ultrasonic) and other spectrums of light. Furthermore, it is anticipated that the wireless technology be either one way from the remote 111 to the receiver 113 or two way. In some embodiments, the processing element 100 receives one or more commands from the remote control 111 to rotate the image displayed on the display 7 by any desired amount, preferably 90, 180 or 270 degrees. In response, the processing element 100 rotates the image and adjusts the aspect ratio or crops the image to fit on the display 7.

In some embodiments, one or more sensors 30/32 and optional amplifiers/detectors 31/33 detect that the device 5 has been rotated and signal the processing element 100. Responsive to the detected rotation of the device 5, the processing element 100 rotates the image and adjusts the aspect ratio or crops the image to fit on the display 7. The sensors are any orientation sensor or sensors, as known in the industry.

In the example shown, audio emanates from either the broadcast receiver 102, the legacy source (e.g., S-Video) or a discrete analog audio input (Audio-IN). If the audio source is digital, the processing element 100 routes the audio to, for example, a digital-to-analog converter 106 and then to an input of a multiplexer 108. The multiplexer 108, under control of the processing element 100, selects one of the audio sources and routes the selected audio to the audio output and an internal audio amplifier 110. In this example, the internal audio amplifier 110 amplifies the audio and delivers multiple channel outputs (e.g. left channel and right channel outputs) to a switching device or multiplexer 120. The internal speakers 10/12/14/16 are each selectively connected to one of the multiple channels through the switching device 120. In such, it is anticipated that some speakers 10/12/14/16 are not used in some orientations and are, therefore, not connected to any of the audio channels through the switching device 120.

In a simplified example, each speaker 10/12/14/16 is selectively connected to the left audio output through a first relay or analog switch and each speaker 10/12/14/16 is selectively connected to the right audio output through a first relay or analog switch. Thereby, under control of the processing element 100, any speaker is connected to any output of the amplifier 110 under control of the processing element 100.

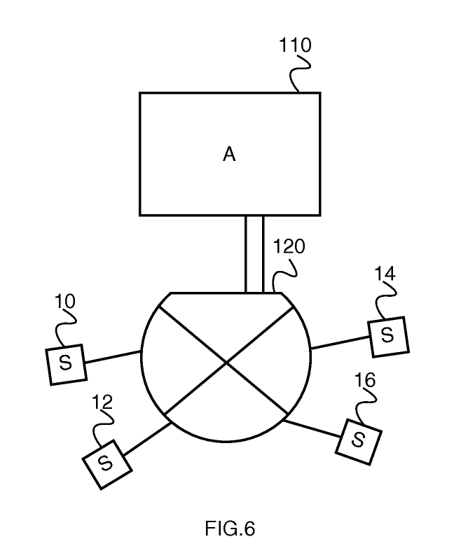

Referring to FIG. 6, a schematic view of an exemplary speaker configuration system will be described. In this example, the speakers 10/12/14/16 are connected to the left output and right output of the amplifier 110 through a cross-point switch or multiplexer 120. The cross point switch or multiplexer 120 connects any (or some) speakers 10/12/14/16 to any output of the amplifier 110 (e.g. left channel or right channel). Therefore, in the scenario of FIG. 1, the left speaker 14 is connected through the switch 120 to the left output of the amplifier 110 and the right speaker 16 is connected to the right output of the amplifier 110. Optionally, the other left speaker 10 is also connected through the switch 120 to the left output channel of the amplifier 110 and the other right speaker 12 is also connected to the right output channel of the amplifier 110.

In this scenario, when rotated 90 degrees as in FIG. 2, either by user directive or by sensing rotation by the sensor(s) 30/32, the speakers 10/12/14/16 are reconfigured. The left bottom speaker 14 (now on the left and top of the device 5) is disconnected by the switch 120. The right bottom speaker 16 (now on the left, bottom side of the device 5) is changed to connect through the switch 120 to the left output of the amplifier 110 and the right top speaker 12 is connected through the switch 120 to the right output of the amplifier 110. Optionally, the other currently left speaker 14 is also connected through the switch 120 to the left output of the amplifier 110 and the other currently right speaker 10 is connected to the right output of the amplifier 110.

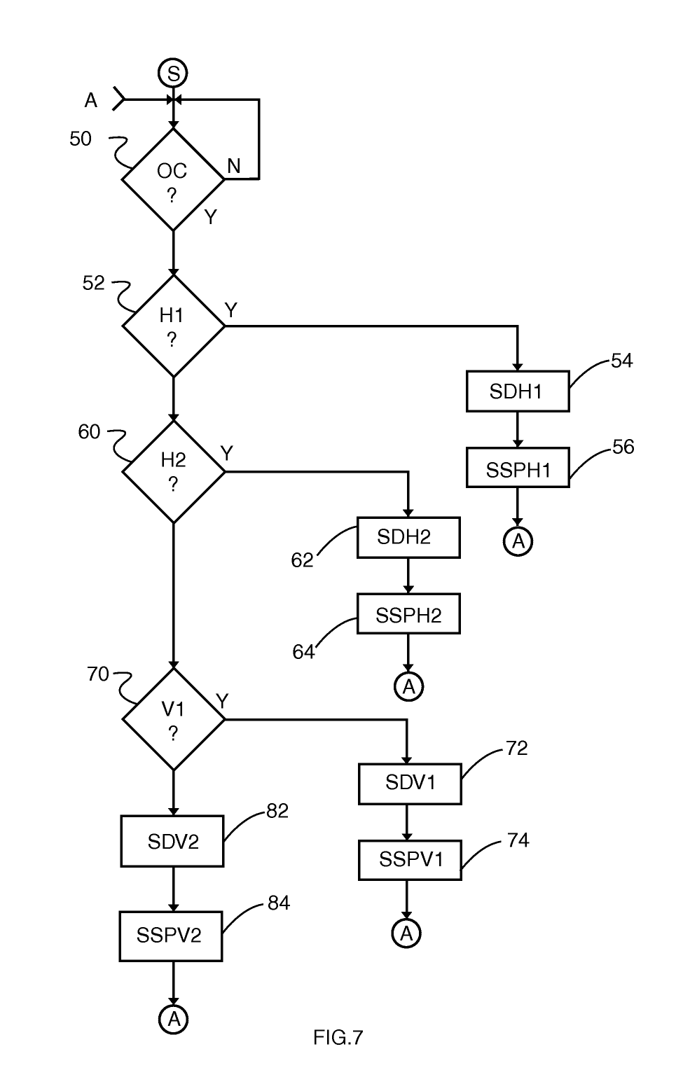

Referring to FIG. 7, a typical flow chart for speaker configuration is described. This is an exemplary flow as executed by, for example, the processing element 100. Flow starts with determining if an orientation change has been made 50. Determination of an orientation change 50 is, for example, by receiving a command from, for example, a remote control 111, a keyboard, a touch screen input, a feature button, etc, as known in the industry. In some embodiments, a change of orientation is detected by a sensor(s) 30/32 and or circuitry 31/33 integrated into the device 5. Such sensors include, but are not limited to accelerometers, tilt sensors, gyroscopes, fluid level sensors, etc. If no change has been made, nothing needs to be done. If a change in orientation has occurred 50, the new orientation is determined. In this example, it is assumed that there are four possible orientations of zero, 90, 180 and 270 degrees. Any intermediate rotation (e.g. 95 degrees) is rounded to the nearest of the four possible orientations (e.g. 95 degrees is rounded to 90 degrees). It is also anticipated that, in some embodiments, hysteresis is provided so that, for example, a mid-point of rotation is passed (e.g. 45 degrees) the display 7 and speakers 10/12/14/16 don't shift rapidly back and forth. For example, the display 7 and speakers 10/12/14/16 remain in the non-rotated mode (zero degrees) until the device 5 is rotated past 45 degrees, at which the display 7 and speakers 10/12/14/16 are rotated to the 90 degree mode and remains that way until the device 5 is rotated back to, for example, 35 degrees at which time the non-rotated mode (zero degrees) is restored.

The flow continues with determining 52 if the device 5 is now oriented in a first horizontal mode (e.g. zero degrees as in FIG. 1). If so, the display 5 is set 54 to the first horizontal configuration and the speaker switch 120 is set 56 to connect the proper speakers 10/12/14/16 to the proper amplifier 110 outputs.

If not 52 the first horizontal configuration, it is determined 60 if the device 5 is now oriented in a second horizontal mode (e.g. 180 degrees as in FIG. 3). If so, the display 5 is set 62 to the second horizontal configuration and the speaker switch 120 is set 64 to connect the proper speakers 10/12/14/16 to the proper amplifier 110 outputs.

If not 60 the second horizontal configuration, it is determined 70 if the device 5 is now oriented in a first vertical mode (e.g. 90 degrees as in FIG. 2). If so, the display 5 is set 72 to the first vertical configuration and the speaker switch 120 is set 74 to connect the proper speakers 10/12/14/16 to the proper amplifier 110 outputs.

If not 70 the first vertical mode, by default, it is determined that the device 5 is now oriented in a second vertical mode (e.g. as in FIG. 4) and the display 5 is set 82 to the first vertical configuration and the speaker switch 120 is set 84 to connect the proper speakers 10/12/14/16 to the proper amplifier 110 outputs.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for configuring speakers associated with a device, the system comprising:
a device having a display and at least two speakers;
a means for detecting an orientation of the device;
a processing element operatively coupled to the display and means for detecting, the processing element controlling an orientation of an image displayed on the display responsive to detecting a change in orientation by the means for detecting;
an amplifier having a plurality of outputs;
a switch, the switch selectively connecting each of the speakers to each of the outputs; and
the processing element controlling the switch such that the speakers connected to each of the outputs correspond to the orientation of the image.

2. The system of claim 1, wherein the detecting of the change in orientation by the means for detecting is in the granularity of zero, 90, 180 and 270 degrees.

3. The system of claim 2, wherein the at least two speakers is four speakers and the amplifier has two outputs, a left output and a right output.

4. The system of claim 3, wherein the four speakers includes a left top speaker, a left bottom speaker, a right top speaker and a right bottom speaker and when the orientation of the device is zero degrees, the left top speaker and the left bottom speaker are connected to the left output and the right top speaker and the right bottom speaker are connected to the right output.

5. The system of claim 4, wherein when the orientation of the device is 90 degrees, the left bottom speaker and the right bottom speaker are connected to the left output and the left top speaker and the right top speaker are connected to the right output.

6. The system of claim 5, wherein when the orientation of the device is 180 degrees, the right top speaker and the right bottom speaker are connected to the left output and the left top speaker and the left bottom speaker are connected to the right output.

7. The system of claim 6, wherein when the orientation of the device is 270 degrees, the left top speaker and the right top speaker are connected to the left output and the right bottom speaker and the left bottom speaker are connected to the right output.

8. The system of claim 1, further comprising a means for locking the speakers in one configuration connected to each of the outputs correspond to the orientation of the image.

9. A method of configuring speakers associated with a device, the method comprising:
providing a device having a display, at least two audio channels and at least two speakers;
determining an orientation of the device;
displaying an image on the display relative to the orientation of the device;
routing the audio channels to the speakers relative to the orientation of the device.

10. The method of claim 9, wherein the routing is performed by software, the software running on a processor the device.

11. The method of claim 9, wherein the step of determining the orientation of the device includes reading one or more sensors and automatically determining the orientation of the device.

12. The method of claim 9, wherein there the at least two speakers is three speakers, the at least two audio channels is a left audio channel and a right audio channel and the orientation of the device is selected from the group consisting of landscape and portrait, a first speaker of the three speakers is located at a left lower corner of the device, a second speaker of the three speakers is located at a right lower corner of the device and a third speaker of the three speakers is located at a left upper corner of the device.

13. The method of claim 12, wherein, if the orientation of the device is landscape, the left output is connected to the first speaker and the right output is connected to the second speaker.

14. The method of claim 12, wherein, if the orientation of the device is portrait, the left output is connected to the third speaker and the right output is connected to the first speaker.

15. A system for configuring speakers associated with a device, the system comprising:
a device having a display, a first speaker, a second speaker, a third speaker, a fourth speaker, a left audio channel, a right audio channel and a means for routing each of the audio channels selectively to any of the speakers;
a detector, the detector detects an orientation of the device in the range of zero, 90, 180 and 270;
when the detector detects an orientation of zero degrees, the left audio channel is routed to the first speaker and the right audio channel is routed to the fourth speaker.

16. The system for configuring speakers associated with a device of claim 15, wherein the detector is a mechanical switch.

17. The system for configuring speakers associated with a device of claim 15, in which when the detector detects an orientation of 90 degrees, the left audio channel is routed to the second speaker and the right audio channel is routed to the first speaker.

18. The system for configuring speakers associated with a device of claim 15, in which when the detector detects an orientation of 180 degrees, the left audio channel is routed to the third speaker and the right audio channel is routed to the second speaker.

19. The system for configuring speakers associated with a device of claim 15, in which when the detector detects an orientation of 270 degrees, the left audio channel is routed to the fourth speaker and the right audio channel is routed to the third speaker.

20. The system for configuring speakers associated with a device of claim 15, wherein the detector is one or more electronic sensors, the electronic sensors determine the degrees of rotation in a granularity of the ranges of zero, 90, 180 and 270.

21. The system for configuring speakers associated with a device of claim 15, wherein the detector reads an input from a viewer of the display, the input corresponding to the degrees of rotation in a granularity of the ranges of zero, 90, 180 and 270.
